(19) United States
(12) Patent Application Publication
(10) Pub. No.: US 2019/0018392 A1
(43) Pub. Date: Jan. 17, 2019

(54) CONTROL APPARATUS AND LEARNING DEVICE

(71) Applicant: FANUC CORPORATION, Yamanashi (JP)

(72) Inventor: Tooru KUBOTA, Yamanashi (JP)

(21) Appl. No.: 16/030,877

(22) Filed: Jul. 10, 2018

(30) Foreign Application Priority Data
Jul. 14, 2017 (JP) 2017-137863

(51) Int. Cl. G05B 19/416

(52) U.S. Cl. CPC G05B 19/4166; G05B 2219/36585; G05B 2219/40499; G05B 2219/39417

(57) ABSTRACT

Provided is a control apparatus outputting commands for respective axes of a machine having a redundant degree of freedom includes: a machine learning device that learns the commands for the respective axes of the machine. The machine learning device has a state observation section that observes, as state variables expressing a current state of an environment, data indicating movements of the respective axes of the machine or an execution state of a program, a determination data acquisition section that acquires determination data indicating an appropriateness determination result of a processing result, and a learning section that learns the movements of the respective axes of the machine or the execution state of the program and the commands for the respective axes of the machine, which are associated with one another, by using the state variables and the determination data.

### BACKGROUND OF THE INVENTION

### 1. Field of the Invention

The present invention relates to a control apparatus and a learning device and, in particular, to a control apparatus that optimizes commands for a machine having a redundant degree of freedom.

### 2. Description of the Related Art

Conventional processing programs used in control apparatuses are generally composed of commands following the axis configurations of machines. That is, the conventional processing programs directly define the movements of the respective axes of the machines. Therefore, the conventional processing programs are not intuitive in terms of processing workpieces (specifying the shapes of the workpieces). Further, when the axis configurations are changed at the replacement of the machines or the like, there occurs a problem in that the processing programs are also required to be updated. Such programs are called programs having no redundant degree of freedom, i.e., programs having no degree of freedom in the axis configurations with respect to processing commands.

In order to address the above problems, some methods for generating programs having a redundant degree of freedom have been proposed. For example, there has been known a technology called tool center point control (TCP) in which the position and the posture of a tool (a vector in the direction of the tool) are commanded according to a program with the coordinate system of a workpiece (strictly, a table) as a reference. For example, under the TCP, the position and the posture of a tool are commanded like the following form (1). Here, X, Y, and Z indicate the position of the tip end of the tool, and I, J, and K indicate the posture of the tool. The movements of axes are automatically determined by a control apparatus.

X_Y_Z_I_J_K_; (1)

Further, Japanese Patent Application No. 2016-240446 has disclosed a technology for commanding any control point set in a machine according to a program when seen from any coordinate system set in the machine or a workpiece.

By the use of a redundant degree of freedom, processing performance such as cycle time and processing surface quality may be improved. With a redundant degree of freedom, the movements of the respective axes of a machine may be arbitrarily changed under prescribed constraint conditions. Therefore, an application degree of acceleration and deceleration or the like may be changed. As a result, it is possible to change cycle time, processing accuracy, processing surface quality, or the like.

As a technology for controlling a machine having a redundant degree of freedom, there has been devised a technology for minimizing the solution of an objective function. Here, the objective function is, for example, one obtained in such a way that evaluation standards such reducing cycle time and increasing processing accuracy are formulated using the position of a tool, etc., as inputs and values of commands for the respective axes of a machine as outputs (see Japanese Patent Application Laid-open No. 2015-54393 as an example).

As described above, conventional technologies for controlling machines having a redundant degree of freedom require the formulation of evaluation standards. The application of the technologies to improvement in processing performance causes the following problems. Processing results are affected by various factors such as the installation environments of machines and mechanical characteristics. Such factors are important since they greatly affect processing results. However, it is actually impossible to formulate all the factors affecting the processing results. Further, since targets with which control apparatuses are to be combined and the installation places of the machines are not predictable, it is difficult to include the above factors in objective functions in advance.

### SUMMARY OF THE INVENTION

The present invention has been made in order to address the above problems and has an object of providing a control apparatus and a learning device that optimize commands for a machine having a redundant degree of freedom.

A control apparatus according to an embodiment of the present invention outputs commands for respective axes of a machine having a redundant degree of freedom. The control apparatus includes: a machine learning device that learns the commands for the respective axes of the machine, wherein the machine learning device has a state observation section that observes, as state variables expressing a current state of an environment, data indicating movements of the respective axes of the machine or an execution state of a program, a determination data acquisition section that acquires determination data indicating an appropriateness determination result of a processing result, and a learning section that learns the movements of the respective axes of the machine or the execution state of the program and the commands for the respective axes of the machine, which are associated with one another, by using the state variables and the determination data.

In the control apparatus according to the embodiment of the present invention, the state variables include at least any one of positions, feed rates, accelerations, and jerks as the data indicating the movements of the respective axes of the machine.

In the control apparatus according to the embodiment of the present invention, the determination data includes an appropriateness determination result of at least any one of a feed rate and a position of a tool.

In the control apparatus according to the embodiment of the present invention, the determination data includes an appropriateness determination result of at least any one of cycle time, processing accuracy, and processing surface quality.

In the control apparatus according to the embodiment of the present invention, the learning section has: a reward calculation section that calculates a reward relating to the appropriateness determination result; and a value function update section that updates, by using the reward, a function expressing values of the commands for the respective axes of the machine with respect to the movements of the respective axes of the machine or the execution state of the program.

In the control apparatus according to the embodiment of the present invention, the learning section performs calculation of the state variables and the determination data in a multilayer structure.

The control apparatus according to the embodiment of the present invention further includes: a decision-making section that outputs a command value indicating the commands for the respective axes of the machine according to a learning result of the learning section.

In the control apparatus according to the embodiment of the present invention, the learning section learns the commands for the respective axes of the machine by using the state variables and the determination data obtained from a plurality of machines.

In the control apparatus according to the embodiment of the present invention, the machine learning device exists in a cloud server.

A learning device according to another embodiment of the present invention learns commands for respective axes of a machine having a redundant degree of freedom. The learning device includes: a state observation section that observes, as state variables expressing a current state of an environment, data indicating movements of the respective axes of the machine or an execution state of a program; a determination data acquisition section that acquires determination data indicating an appropriateness determination result of a processing result; and a learning section that learns the movements of the respective axes of the machine or the execution state of the program and the commands for the respective axes of the machine, which are associated with one another, by using the state variables and the determination data.

According to an embodiment of the present invention, it is possible to provide a control apparatus and a learning device that optimize commands for a machine having a redundant degree of freedom.

### BRIEF DESCRIPTION OF THE DRAWINGS

The above and other objects and features of the present invention will become apparent from the descriptions of the following embodiments with reference to the accompanying drawings in which;

FIG. 1 is a diagram showing an example of a control method of a machine having a redundant degree of freedom;

FIG. 2 is a diagram showing an example of a control method of a machine having a redundant degree of freedom;

FIG. 3 is a schematic function block diagram showing an embodiment of a control apparatus;

FIG. 4 is a schematic function block diagram showing an embodiment of the control apparatus;

FIG. 5 is a flowchart showing an embodiment of a machine learning method;

FIG. 6 is a flowchart showing an embodiment of a machine learning method;

FIG. 7A is a flowchart showing an embodiment of a machine learning method;

FIG. 7B is a flowchart showing an embodiment of the machine learning method;

FIG. 8A is a diagram for describing a neuron;

FIG. 8B is a diagram for describing a neural network;

FIG. 9 is a schematic function block diagram showing an embodiment of a control apparatus 2;

FIG. 10 is a schematic function block diagram showing an embodiment of a system in which control apparatuses are incorporated;

FIG. 11 is a schematic function block diagram showing an embodiment of a system in which a control apparatus is incorporated; and

FIG. 12 is a schematic function block diagram showing an embodiment of a control system in which a control apparatus is incorporated.

### DETAILED DESCRIPTION OF THE PREFERRED EMBODIMENTS

First, in order to facilitate the understanding of the present invention, the outline of a control method in a case in which a machine has a redundant degree of freedom will be described using some examples.

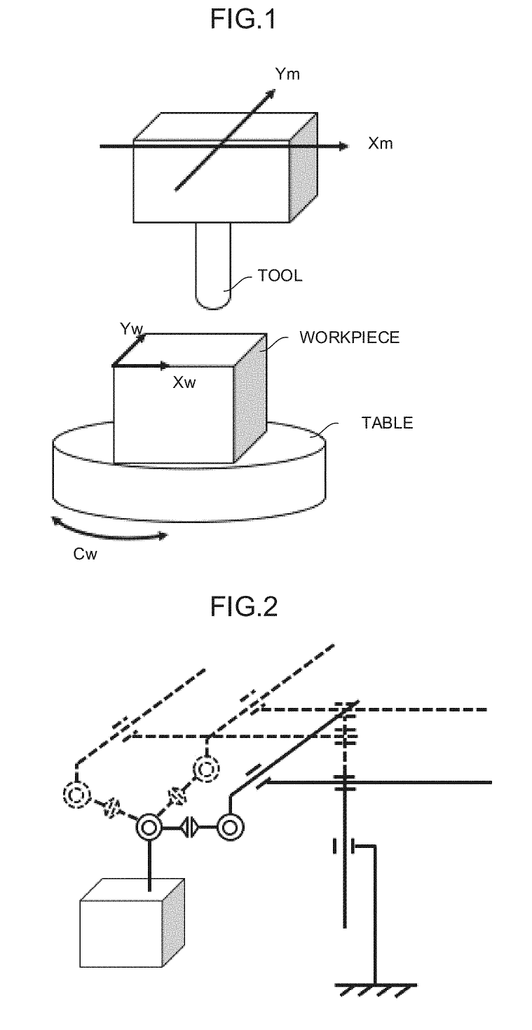

As shown in FIG. 1, consideration is given to a case in which a machine having X, Y, and C axes performs a program for moving the X and Y axes with respect to a coordinate system (hereinafter called a workpiece coordinate system Σ_{w}) set on a workpiece. A control apparatus outputs commands for the respective axes of the machine based on a machine coordinate system Σₘ. When a processing program for drawing a circle going round about the origin of the machine coordinate system Σₘ on the X-Y plane of the workpiece coordinate system Σ_{w}, there are an infinite number of methods for controlling the respective axes of the machine with the control apparatus. For example, it is expected that the following methods (1) to (3) be performed. In the method (1), Xₘ and Yₘ are moved, while Cₘ is fixed. That is, a tool is moved by the combination of Xₘ and Yₘ to draw an arc, while a workpiece on a table is stopped.

In the method (2), Cₘ is rotated, while Xₘ and Yₘ are fixed. That is, the workpiece on the table is rotated without moving the tool. In the method (3), Xₘ, Yₘ, and Cₘ are alternately moved. That is, both the table and the tool are moved. Since each of the above control methods has different processing time and different processing accuracy, the control apparatus is required to select any of the methods according to its control purpose and output commands for the respective axes of the machine for each control cycle.

Further, a machine having three orthogonal axes and three rotation axes and using a rotation tool always has a redundant degree of freedom with respect to a program. As shown in FIG. 2, the number of the positions of the respective axes of a machine that realize the position and the posture of a tool on a workpiece is infinite if the limitations of strokes are not taken into consideration. A control apparatus is required to select one of the combinations of such an infinite number of the positions of the respective axes of a machine and output commands for the respective axes of the machine for each control cycle.

The present invention provides, when controlling a machine having a redundant degree of freedom as described above, a technology for determining an optimum method for moving respective axes with a control apparatus according to purposes such as placing priority on processing time, placing priority on processing accuracy, and placing emphasis on the balance of both processing time and processing accuracy.

### First Embodiment

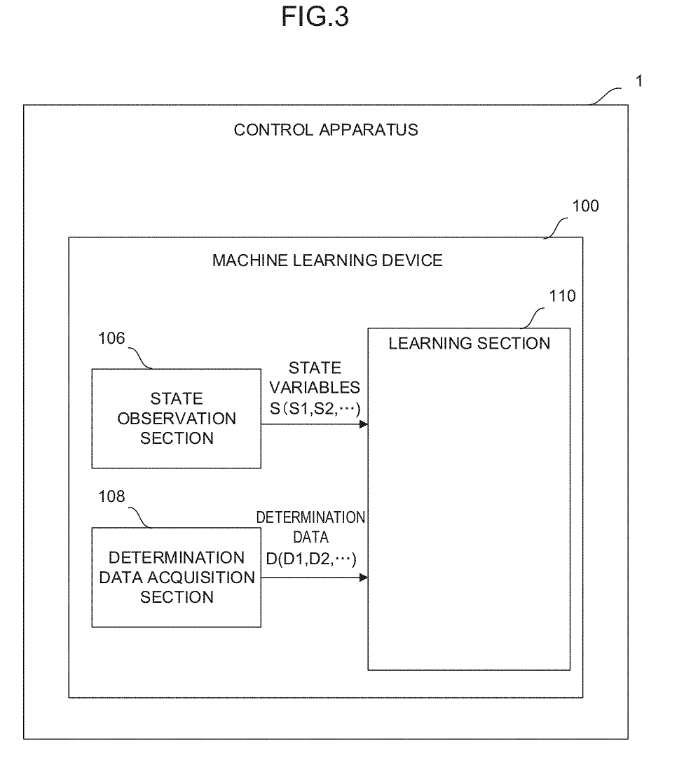

Hereinafter, an embodiment of the present invention will be described using the drawings. First, the configuration of a control apparatus 1 according to a first embodiment of the present invention will be described using the block diagram of FIG. 3. The control apparatus 1 includes a machine learning device 100. The machine learning device 100 includes software (such as a learning algorithm) and hardware (such as a processor) for spontaneously learning commands for the respective axes of a machine with respect to the movements (such as the positions, the feed rates, the accelerations, and the jerks) of the respective axes of the machine or the execution state of a program through so-called machine learning.

In this case, an object learned by the machine learning device 100 of the control apparatus 1 corresponds to a model structure expressing the correlation between the movements (such as the positions, the feed rates, the accelerations, and the jerks) of the respective axes of the machine or the execution state of the program and the commands for the respective axes of the machine.

As shown in the function block of FIG. 3, the machine learning device 100 of the control apparatus 1 includes a state observation section 106, a determination data acquisition section 108, and a learning section 110. The state observation section 106 observes, as state variables S expressing the current state of an environment, data indicating the movements (such as the positions, the feed rates, the accelerations, and the jerks) of the respective axes of the machine or the execution state of the program. The determination data acquisition section 108 acquires the feed rate and the position of a tool as determination data D. Using the state variables S and the determination data D, the learning section 110 learns the movements of the respective axes of the machine or the execution state of the program and the commands for the respective axes of the machine, which are associated with one another. Note that the determination data acquisition section 108 may acquire cycle time, processing accuracy, and processing surface quality as the determination data D.

The state observation section 106 may be configured as, for example, one of the functions of the processor of the control apparatus 1. Alternatively, the state observation section 106 may be configured as, for example, software for functioning the processor.

As the movements (such as the positions, the feed rates, the accelerations, and the jerks) of the respective axes of the machine or the execution state of the program among the state variables S, the control apparatus 1 may calculate or acquire these values for each control cycle and input the calculated or acquired values to the state observation section 106.

The determination data acquisition section 108 may be configured as, for example, one of the functions of the processor of the control apparatus 1. Alternatively, the determination data acquisition section 108 may be configured as, for example, software for functioning the processor.

When using the feed rate and the position of the tool as the determination data D, the control apparatus 1 may calculate or acquire these values for each control cycle and input the calculated or acquired values to the determination data acquisition section 108. That is, in this case, the control cycle corresponds to a learning cycle. On this occasion, the determination data D is basically calculated based on a processing result over one cycle (several milliseconds) but may be calculated based on a processing result over a longer span (e.g., one second in the past). On the other hand, when using cycle time, processing accuracy, and processing surface quality as the determination data D, the control apparatus 1 may calculate or acquire these values for each appropriate timing during processing such as the end of a cutting block or a program. For example, the cycle time of the cutting block or the program is measurable by the control apparatus 1, and the processing accuracy and the processing surface quality are measurable inside the machine when a camera or a laser sensor is put in a measurement mode at the end of the cutting block or the program. The determination data acquisition section 108 may acquire these measurement values as the determination data D. In this case, learning is performed for one cycle at each appropriate timing during processing.

When considered in terms of the learning cycle of the learning section 110, the state variables S input to the learning section 110 are those based on data at a previous learning cycle at which the determination data D is acquired. That is, while the machine learning device 100 of the control apparatus 1 advances the learning, the acquisition of the state variables S, the output of the commands for the respective axes of the machine adjusted based on the state variables S, and the acquisition of the determination data D are repeatedly performed in an environment.

The learning section 110 may be configured as, for example, one of the functions of the processor of the control apparatus 1. Alternatively, the learning section 110 may be configured as, for example, software for functioning the processor. According to any learning algorithm collectively called machine learning, the learning section 110 learns the commands for the respective axes of the machine with respect to the movements (such as the positions, the feed rates, the accelerations, and the jerks) of the respective axes of the machine or the execution state of the program. The learning section 110 may repeatedly perform the learning based on a data set including the state variables S and the determination data D for each control cycle or at each appropriate timing during processing.

By repeatedly performing such a learning cycle, the learning section 110 may automatically identify a feature suggesting the correlation between the state variables S indicating the movements (such as the positions, the feed rates, the accelerations, and the jerks) of the respective axes of the machine or the execution state of the program and the commands for the respective axes of the machine. Although the correlation between the state variables S and the commands for the respective axes of the machine is substantially unknown at the start of a learning algorithm, the learning section 110 gradually identifies the feature of the correlation and interprets the correlation as the learning is advanced. When the correlation between the state variables S and the commands for the respective axes of the machine is interpreted to a certain reliable extent, learning results repeatedly output by the learning section 110 may be used to select the action (that is, decision making) of determining what values are desirably taken as the commands for the respective axes of the machine with respect to a current state (that is, the movements (such as the positions, the feed rates, the accelerations, and the jerks) of the respective axes of the machine or the execution state of the program).

As described above, in the machine learning device 100 of the control apparatus 1, the learning section 110 learns the commands for the respective axes of the machine according to the machine learning algorithm using the state variables S observed by the state observation section 106 and the determination data D acquired by the determination data acquisition section 108. The state variables S are composed of data such as the movements (such as the positions, the feed rates, the accelerations, and the jerks) of the respective axes of the machine or the execution state of the program. Further, the determination data D is uniquely calculated by the acquisition of the feed rate and the position (or the cycle time, the processing accuracy, and the processing surface quality) of the tool. Accordingly, the machine learning device 100 of the control apparatus 1 may automatically and accurately calculate the commands for the respective axes of the machine with respect to the movements (such as the positions, feed rates, acceleration, and jerks) of the respective axes of the machine or the execution state of the program without relying on calculation or estimation.

Where it is possible to automatically calculate the commands for the respective axes of the machine without relying on calculation or estimation, appropriate values as the commands for the respective axes of the machine may be quickly determined only by understanding the movements (such as the positions, the feed rates, the accelerations, and the jerks) of the respective axes of the machine or the execution state of the program. Accordingly, the commands for the respective axes of the machine may be efficiently determined.

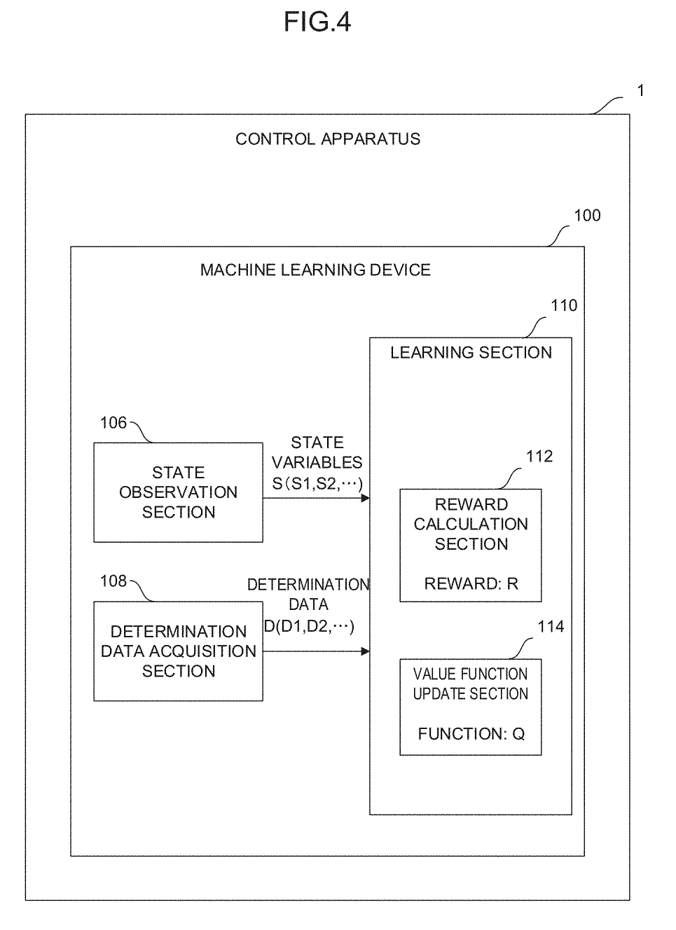

In the machine learning device 100 having the above configuration, the learning algorithm performed by the learning section 110 is not particularly limited but a known learning algorithm may be employed as the machine learning. FIG. 4 shows, as an embodiment of the control apparatus 1 shown in FIG. 3, a configuration including the learning section 110 that performs reinforcement learning as an example of the learning algorithm. The reinforcement learning is a method in which, while the current state (that is, an input) of an environment in which a learning target exists is observed, a prescribed action (that is, an output) is performed in the current state and the cycle of giving any reward to the action is repeatedly performed by trial and error to learn measures (the determination of the commands for the respective axes of the machine in the machine learning device of the present application) to maximize the total of rewards as an optimum solution.

In the machine learning device 100 of the control apparatus 1 shown in FIG. 4, the learning section 110 includes a reward calculation section 112 and a value function update section 114. The reward calculation section 112 calculates rewards R relating to appropriateness determination results (corresponding to the determination data D used in the next learning cycle at which the state variables S are acquired) of the feed rate and the position (or the cycle time, the processing accuracy, and the processing surface quality) of the tool in a case in which the commands for the respective axes of the machine are determined based on the state variables S. The value function update section 114 updates, using the calculated reward R, a function Q expressing values of the commands for the respective axes of the machine. The learning section 110 learns the optimum solution of the commands for the respective axes of the machine in such a way that the value function update section 114 repeatedly updates the function Q.

An example of a reinforcement learning algorithm performed by the learning section 110 will be described. The algorithm in this example is known as Q-learning and expresses a method in which a state s of an action subject and an action a possibly taken by the action subject in the state s are assumed as independent variables and a function Q(s, a) expressing an action value when the action a is selected in the state s is learned. The selection of the action a by which the value function Q becomes the largest in the state s results in an optimum solution. By starting the Q-learning in a state in which the correlation between the state s and the action a is unknown and repeatedly performing the selection of various actions a by trial and error in any state s, the value function Q is repeatedly updated to be approximated to an optimum solution. Here, when an environment (that is, the state s) changes as the action a is selected in the state s, a reward (that is, weighting of the action a) r is obtained according to the change and the learning is directed to select an action a by which a higher reward r is obtained. Thus, the value function Q may be approximated to an optimum solution in a relatively short period of time.

Generally, the update formula of the value function Q may be expressed like the following Formula (1). In Formula (1), sₜ and aₜ express a state and an action at time t, respectively, and the state changes to sₜ₊₁ with the action aₜ. rₜ₊₁ expresses a reward obtained when the state changes from sₜ to sₜ₊₁. Q in the term of maxQ expresses a case in which an action a by which the maximum value Q is obtained at time t+1 (which is assumed at time t) is performed. α and γ express a learning coefficient and a discount rate, respectively, and arbitrarily set to fall within 0<α≤1 and 0<γ≤1, respectively.

$$Q ( {s}_{t} , {a}_{t} ) ← Q ( {s}_{t} , {a}_{t} ) + α ( {r}_{t + 1} + γ {max}_{a} Q ( {s}_{t + 1} , a ) - Q ( {s}_{t} , {a}_{t} ) ) \qquad ( Formula 1 )$$

When the learning section 110 performs the Q-learning, the state variables S observed by the state observation section 106 and the determination data D acquired by the determination data acquisition section 108 correspond to the state s in the update formula, the action of determining the commands for the respective axes of the machine with respect to a current state (that is, the movements (such as the positions, the feed rates, the accelerations, and the jerks) of the respective axes of the machine or the execution state of the program) corresponds to the action a in the update formula, and the rewards R calculated by the reward calculation section 112 correspond to the reward r in the update formula. Accordingly, the value function update section 114 repeatedly updates the function Q expressing values of the outputs of the commands for the respective axes of the machine with respect to the current state by the Q-learning using the rewards R.

For example, the rewards R calculated by the reward calculation section 112 may be positive (plus) if the appropriateness determination results of the feed rate and the position (or the cycle time, the processing accuracy, and the processing surface quality) of the tool are determined to be “appropriate” and may be negative (minus) if the appropriateness determination results are determined to be “inappropriate” when the respective axes of the machine are controlled based on determined commands after the outputs of the commands for the respective axes of the machine are determined.

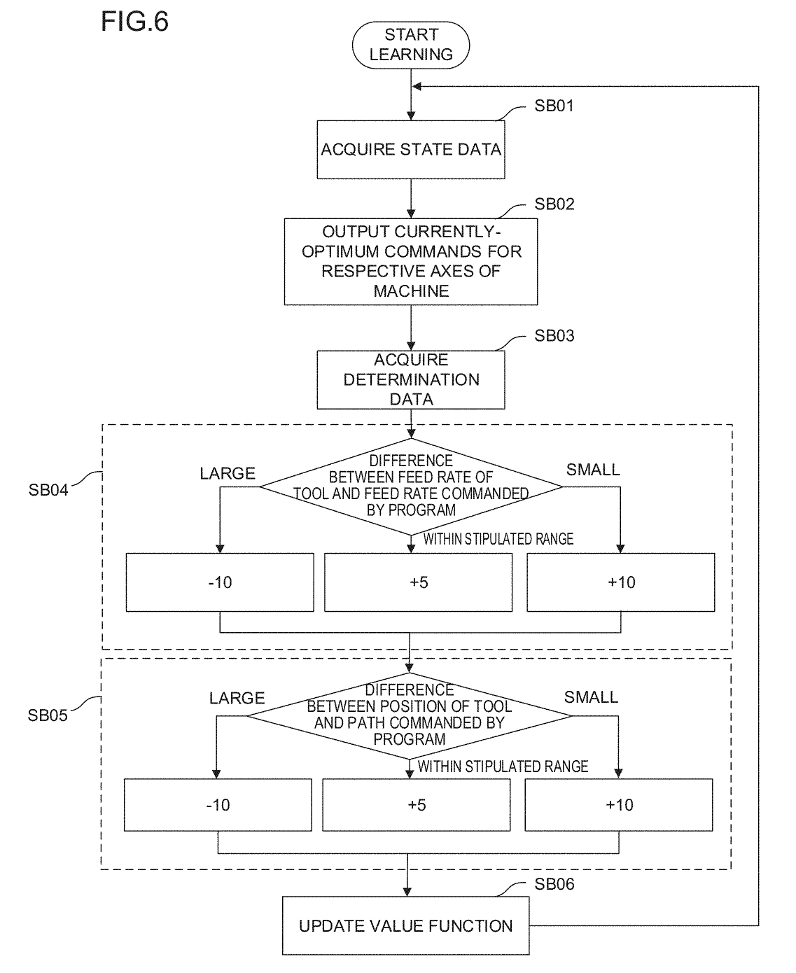

For example, when the learning is performed for each control cycle, the rewards R may be set at +5 if the difference between the feed rate of the tool and a feed rate commanded by a program falls within the range of a prescribed feed rate difference, may be set at +10 if the difference exceeds the range of the feed rate difference and the feed rate of the tool is faster, and may be set at −10 if the difference exceeds the range of the feed rate difference and the feed rate of the tool is slower. Thus, the function Q evaluates that a command for accelerating cycle time has a larger value. Further, the rewards R may be set at +5 if the difference between the position of the tool and a path commanded by the program falls within the range of a prescribed error, may be set at +10 if the difference is smaller than the range of the error, and may be set at −10 if the difference is larger than the range of the error. Thus, the function Q evaluates that a command for increasing processing accuracy has a larger value (see FIG. 6).

Further, when the learning is performed at each appropriate timing during processing, the rewards R may be set at +0 if the cycle time falls within the range of prescribed time, may be set at +5 if the cycle time is shorter than the range of the prescribed time, and may be set at −5 if the cycle time is longer beyond the range of the prescribed time. Thus, the function Q evaluates that a command for accelerating the cycle time has a larger value. Further, the rewards R may be set at +0 if an evaluation value of the processing accuracy falls within a prescribed range, may be set at +5 if the evaluation value is allowed to exceed the prescribed range, and may be set at −5 if the evaluation value is not allowed to exceed the prescribed range.

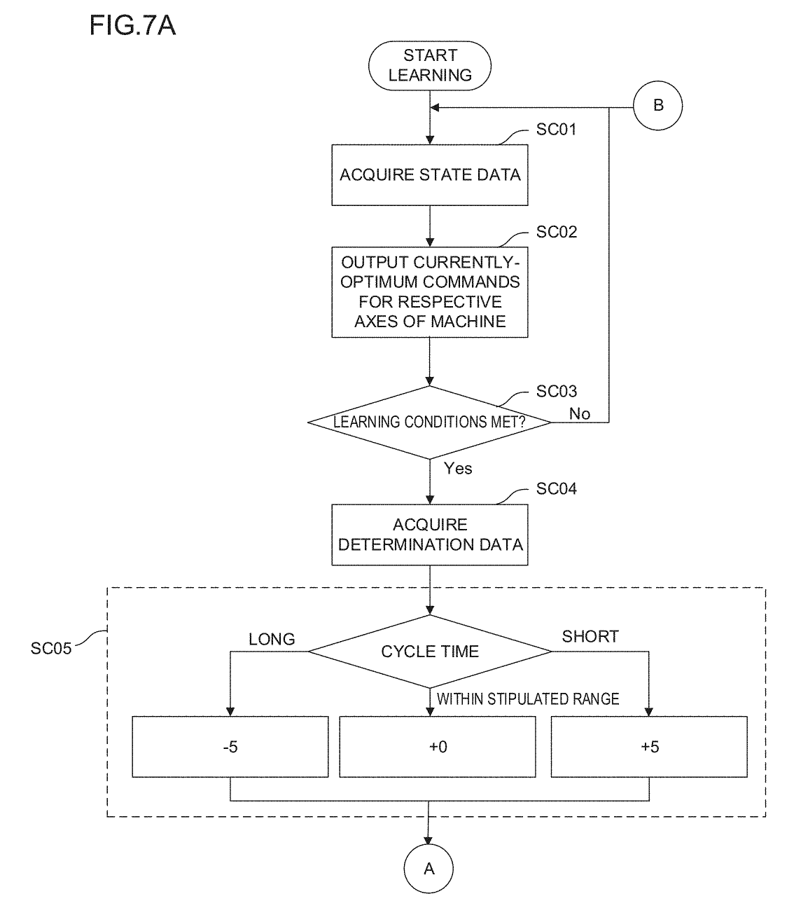

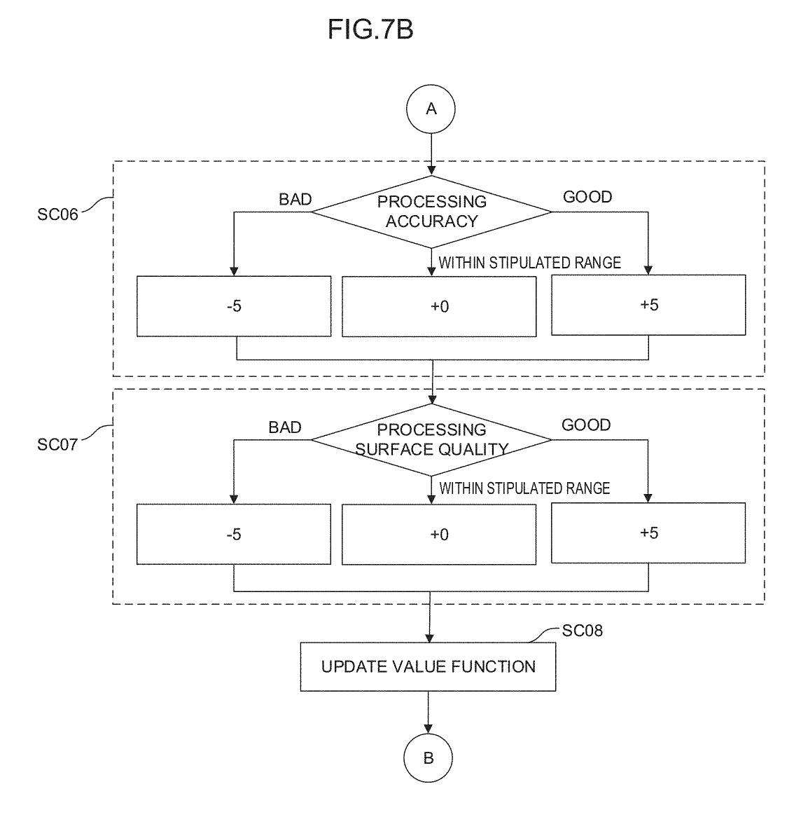

Thus, the function Q evaluates that a command for improving the processing accuracy has a larger value. Further, the rewards R may be set at +0 if an evaluation value of the processing surface quality falls within a prescribed range, may set at +5 if the evaluation value is allowed to exceed the prescribed range, and may be set at −5 if the evaluation value is not allowed to exceed the prescribed range. Thus, the function Q evaluates that a command for improving the processing surface quality has a larger value (see FIGS. 7A and 7B).

The value function update section 114 may have an action value table in which the state variables S, the determination data D, and the rewards R are organized in association with action values (for example, numeric values) expressed by the function Q. In this case, the action of updating the function Q with the value function update section 114 is equivalent to the action of updating the action value table with the value function update section 114. At the start of the Q-learning, the correlation between the current state of an environment and the quantity of adjustment of the movement feed rate of each motor of a robot is unknown. Therefore, in the action value table, various kinds of the state variables S, the determination data D, and the rewards R are prepared in association with values (function Q) of randomly-set action values. Note that the reward calculation section 112 may immediately calculate the rewards R corresponding to the determination data D when the determination data D is known, and the calculated rewards R are written in the action value table.

When the Q-learning is advanced using the rewards R corresponding to appropriateness determination results of the feed rate and the position (or the cycle time, the processing accuracy, and the processing surface quality) of the tool, the learning is directed to select the action of obtaining higher rewards R. Then, values (function Q) of action values for an action performed in a current state are rewritten to update the action value table according to the state of an environment (that is, the state variables S and the determination data D) that changes as the selected action is performed in the current state. By repeatedly performing the update, values (the function Q) of action values displayed in the action value table are rewritten to be larger as an action is more appropriate. Thus, the correlation between the current state of an unknown environment (the movements (such as the positions, the feed rates, the accelerations, and the jerks) of the respective axes of the machine or the execution state of the program) and a corresponding action (the commands for the respective axes of the machine) becomes gradually obvious. That is, by the update of the action value table, the relationship between the movements (such as the positions, the feed rates, the accelerations, and the jerks) of the respective axes of the machine or the execution state of the program and the commands for the respective axes of the machine is gradually approximated to an optimum solution.

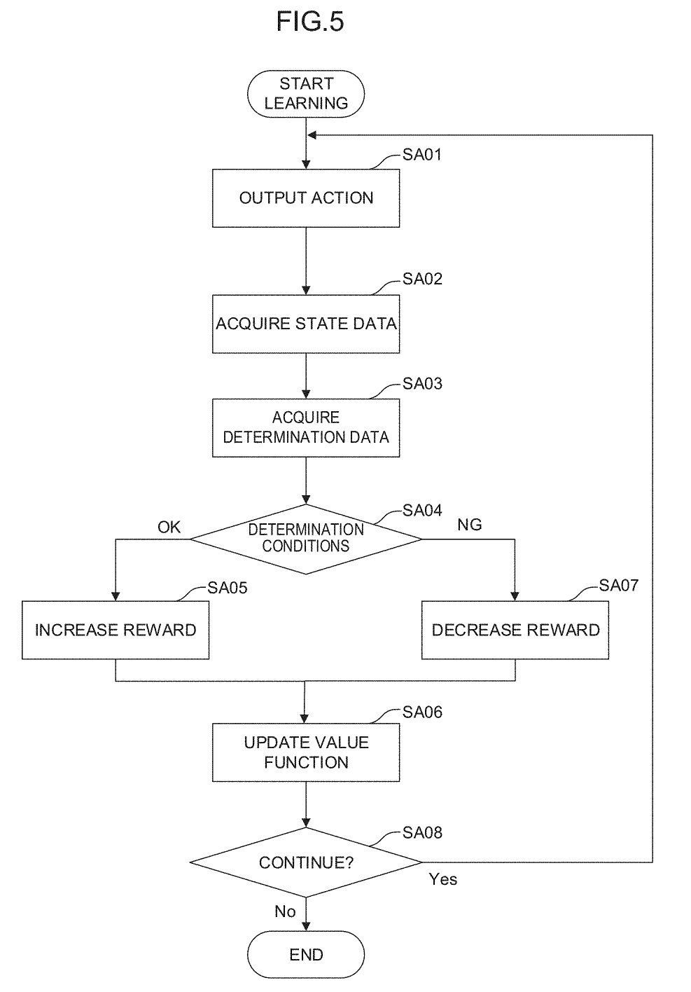

The flow of the above Q-learning (that is, an embodiment of a machine learning method) performed by the learning section 110 will be further described with reference to FIG. 5. First, in step SA01, the value function update section 114 randomly selects, by referring to an action value table at that time, commands for the respective axes of the machine as an action performed in a current state indicated by the state variables S observed by the state observation section 106. Next, the value function update section 114 imports the state variable S in the current state observed by the state observation section 106 in step SA02, and imports the determination data D in the current state acquired by the determination data acquisition section 108 in step SA03. Then, in step SA04, the value function update section 114 determines if the commands for the respective axes of the machine are appropriate based on the determination data D. If the commands for the respective axes of the machine are appropriate, the value function update section 114 applies a positive reward R calculated by the reward calculation section 112 to the update formula of the function Q in step SA05. Next, in step SA06, the value function update section 114 updates the action value table using the state variable S and the determination data D in the current state, the reward R, and a value (updated function Q) of an action value. If it is determined in step SA04 that the commands for the respective axes of the machine are inappropriate, the value function update section 114 applies a negative reward R calculated by the reward calculation section 112 to the update formula of the function Q in step SA07. Then, in step SA06, the value function update section 114 updates the action value table using the state variable S and the determination data D in the current state, the reward R, and the value (updated function Q) of the action value. The learning section 110 updates the action value table over again by repeatedly performing the processing of steps SA01 to SA07 and advances the learning of the optimum solution of the commands for the respective axes of the machine. Note that the processing for calculating the reward R and the processing for updating the value function in the steps SA04 to SA07 are performed for each data included in the determination data D.

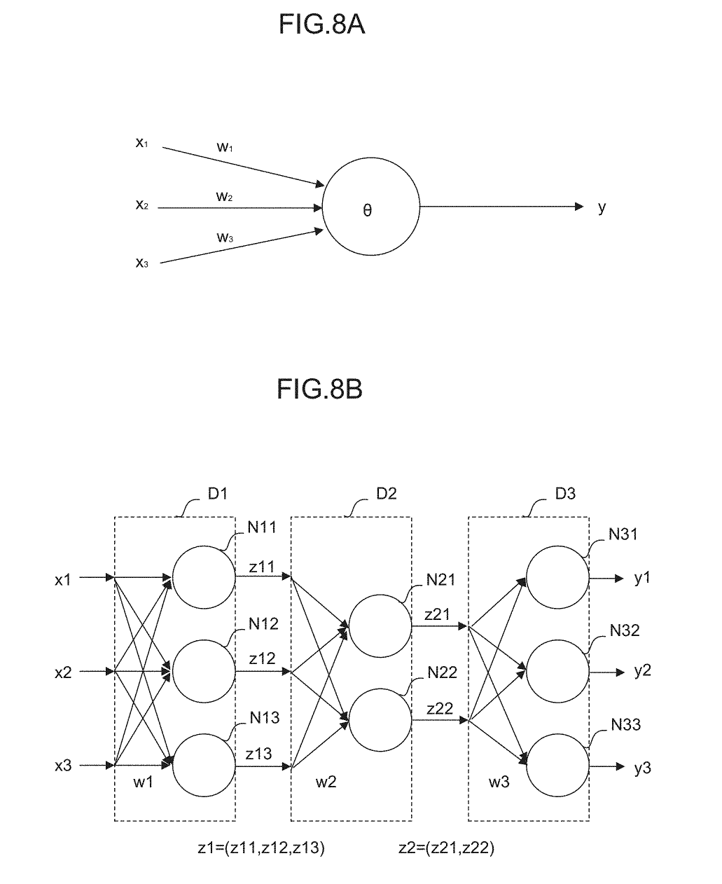

In advancing the above reinforcement learning, a neural network may be, for example, used instead of the Q-learning. FIG. 8A schematically shows a neuron model. FIG. 8B schematically shows the model of a neural network having three layers in which the neurons shown in FIG. 8A are combined together. The neural network may be configured by, for example, a calculation unit, a storage unit, or the like following a neuron model.

The neuron shown in FIG. 8A outputs a result y with respect to a plurality of inputs x (here, inputs x₁ to x₃ as an example). The inputs x₁ to x₃ are multiplied by corresponding weights w (w₁ to w₃), respectively. Thus, the neuron outputs the result y expressed by the following Formula 2. Note that in the following Formula 2, an input x, a result y, and a weight w are all vectors. In addition, θ expresses a bias, and fₖ expresses an activation function.

y=ƒₖ(Σᵢ₌₁ⁿxᵢwᵢ−θ) (Formula 2)

In the neural network having the three layers shown in FIG. 8B, a plurality of inputs x (here, inputs x1 to x3 as an example) is input from the left side of the neural network, and results y (here, results y1 to y3 as an example) are output from the right side of the neural network. In the example shown in FIG. 8B, the inputs x1 to x3 are multiplied by corresponding weights (collectively expressed as w1) and input to three neurons N11 to N13, respectively.

In FIG. 8B, the respective outputs of the neurons N11 to N13 are collectively expressed as z1. The outputs z1 may be regarded as feature vectors obtained by extracting feature amounts of the input vectors. In the example shown in FIG. 8B, the respective feature vectors z1 are multiplied by corresponding weights (collectively indicated as w2) and input to two neurons N21 and N22, respectively. The feature vectors z1 express the features between the weights w1 and the weights w2.

In FIG. 8B, the respective outputs of neurons N21 and N22 are collectively expressed as z2. The outputs z2 may be regarded as feature vectors obtained by extracting feature amounts of the feature vectors z1. In the example shown in FIG. 8B, the respective feature vectors z2 are multiplied by corresponding weights (collectively indicated as w3) and input to three neurons N31 to N33, respectively. The feature vectors z2 express the features between the weights w2 and the weights w3. Finally, the neurons N31 to N33 output the results y1 to y3, respectively.

Note that it is possible to employ so-called deep learning in which a neural network forming three or more layers is used.

In the machine learning device 100 of the control apparatus 1, the learning section 110 performs the calculation of the state variables S and the determination data D as inputs x in a multilayer structure according to the above neural network to be capable of outputting the commands (result y) for the respective axes of the machine. Further, in the machine learning device 100 of the control apparatus 1, the neural network is used as a value function in the reinforcement learning, and the learning section 110 performs the calculation of the state variables S and the action a as inputs x in a multilayer structure according to the above neural network to be capable of outputting the value (result y) of the action in the state. Note that the operation mode of the neural network includes a learning mode and a value prediction mode. For example, it is possible to learn a weight w using a learning data set in the learning mode and determine an action value using the learned weight w in the value prediction mode. Note that detection, classification, deduction, or the like may be performed in the value prediction mode.

The configuration of the above control apparatus 1 may be described as a machine learning method (or software) performed by a processor. The machine learning method is a machine learning method for learning commands for the respective axes of a machine. In the machine learning method, the CPU of a computer performs: the step of observing the movements (such as the positions, the feed rates, the accelerations, and the jerks) of the respective axes of the machine or the execution state of a program as the state variables S expressing the current state of an environment; the step of acquiring the determination data D indicating the appropriateness determination results of the feed rate and the position (or the cycle time, the processing accuracy, and the processing surface quality) of a tool obtained according to the adjusted commands for the respective axes of the machine; and the step of learning the movements (such as the positions, the feed rates, the accelerations, and the jerks) of the respective axes of the machine or the execution state of the program and the commands for the respective axes of the machine, which are associated with one another by using the state variables S and the determination data D.

### Second Embodiment

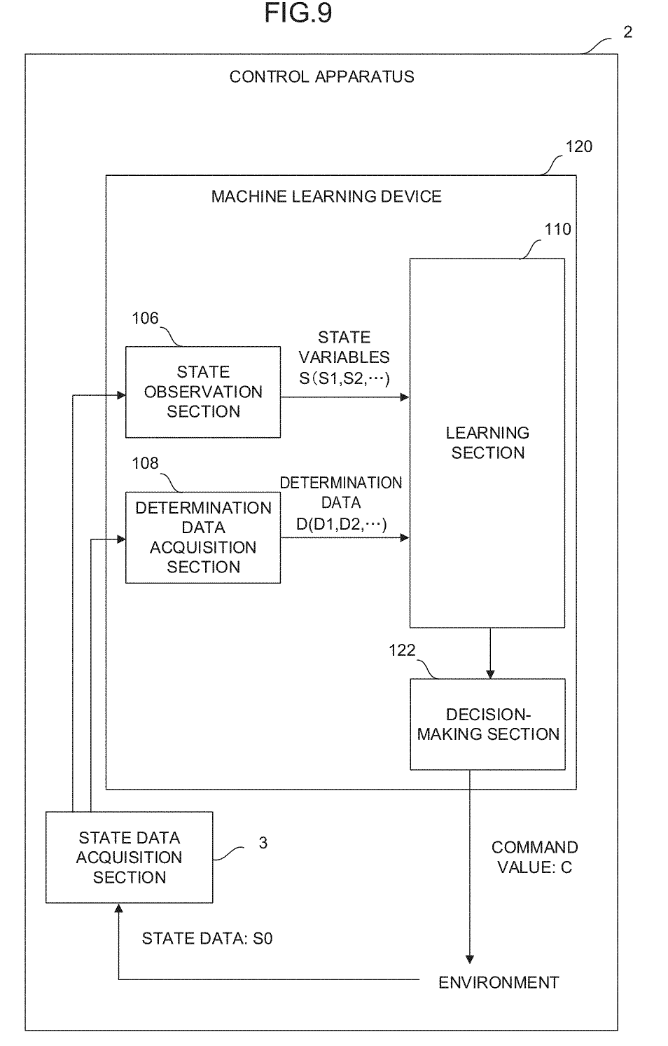

FIG. 9 shows a control apparatus 2 according to a second embodiment. The control apparatus 2 includes a machine learning device 120 and a state data acquisition section 3. The state data acquisition section 3 acquires the movements (such as the positions, the feed rates, the accelerations, and the jerks) of the respective axes of a machine or the execution state of a program indicating state variables S observed by a state observation section 106 as state data S0. The state data acquisition section 3 may acquire the state data S0 from the control apparatus 2, the various sensors of the machine, or the like.

The machine learning device 120 of the control apparatus 2 includes, besides software (such as a learning algorithm) and hardware (such as a processor) for spontaneously learning commands for the respective axes of the machine through machine learning, software (such as a calculation algorithm) and hardware (such as a processor) for outputting the commands for the respective axes of the machine calculated based on a learning result to the control apparatus 2.

In the machine learning device 120 of the control apparatus 2, one common processor may be configured to perform all software such as a learning algorithm and a calculation algorithm.

A decision-making section 122 may be configured as, for example, one of the functions of the processor of the control apparatus 2. Alternatively, the decision-making section 122 may be configured as, for example, software for functioning the processor. The decision-making section 122 generates and outputs a command value C including the commands for the respective axes of the machine with respect to the movements (such as the positions, the feed rates, the accelerations, and the jerks) of the respective axes of the machine or the execution state of the program based on a learning result of the learning section 110. When the decision-making section 122 outputs the command value C to the control apparatus 2, the state of an environment changes correspondingly.

The state observation section 106 observes, in a next learning cycle, state variables S changed after the output of the command value C to the environment by the decision-making section 122. The learning section 110 updates, for example, a value function Q (that is, an action value table) using the changed state variables S to learn the commands for the respective axes of the machine.

The decision-making section 122 outputs, to the control apparatus 2, the command value C indicating the commands for the respective axes of the machine calculated based on the learning result. By repeatedly performing the learning cycle, the machine learning device 120 advances the learning of the commands for the respective axes of the machine and gradually improves the reliability of the commands for the respective axes of the machine determined by the machine learning device 120 itself.

The machine learning device 120 of the control apparatus 2 having the above configuration produces the same effect as that of the machine learning device 100 described above. Particularly, the machine learning device 120 may change the state of the environment with the output of the decision-making section 122. On the other hand, the machine learning device 120 may ask a function corresponding to the decision-making section for reflecting the learning result of the learning section 110 on the environment for an external apparatus.

FIG. 6 specifically shows an example of the flow of Q-learning performed by the learning section 110 of the control apparatus 2 in a case in which the learning is performed for each control cycle. First, in step SB01, the state observation section 106 observes current state variables S changed after a previous action. In step SB02, the decision-making section 122 selects, by referring to an action value table at that time, optimum commands for the respective axes of the machine as an action performed in a current state indicated by the state variables S. Here, the decision-making section 122 may randomly select the commands for the respective axes of the machine with a prescribed probability by referring to the action value table at that time. Thus, learning efficiency may be increased. In step SB03, the learning section 110 imports determination data D in the current state acquired by the determination data acquisition section 108. In step SB04, the learning section 110 determines whether the commands for the respective axes of the machine are appropriate based on the feed rate of a tool in the determination data D. Further, in step SB05, the learning section 110 determines whether the commands for the respective axes of the machine are appropriate based on the position of the tool in the determination data D. When determining in both steps SB04 and SB05 that the commands are appropriate, the learning section 110 applies a positive reward R calculated by the reward calculation section 112 to the update formula of a function Q. When determining that the commands are inappropriate, the learning section 110 applies a negative reward R calculated by the reward calculation section 112 to the update formula of the function Q. Finally, in step SB06, the learning section 110 updates the action value table using the state variables S and the determination data D in the current state, the reward R, and the value of an action value (the updated function Q).

FIGS. 7A and 7B specifically show an example of the flow of Q-learning performed by the learning section 110 of the control apparatus 2 in a case in which the learning is performed at each appropriate timing during processing. First, in step SC01, the state observation section 106 observes current state variables S changed after a previous action. In step SC02, the decision-making section 122 selects, by referring to an action value table at that time, optimum commands for the respective axes of the machine as an action performed in a current state indicated by the state variables S.

Here, the decision-making section 122 may randomly select the commands for the respective axes of the machine with a prescribed probability by referring to the action value table at that time. Thus, learning efficiency may be increased. In step SC03, the learning section 110 determines whether the time suitable for the learning such as the end of a cutting block or a program has come, i.e., whether learning conditions are met. When the learning conditions are not met, the processing proceeds to step SC01. When the learning conditions are met, the processing proceeds to step SC04. In step SC04, the learning section 110 imports determination data D in the current state acquired by the determination data acquisition section 108. In step SC05, the learning section 110 determines whether the commands for the respective axes of the machine are appropriate based on cycle time in the determination data D.

In step SC06, the learning section 110 determines whether the commands for the respective axes of the machine are appropriate based on processing accuracy in the determination data D. In step SC07, the learning section 110 determines whether the commands for the respective axes of the machine are appropriate based on processing surface quality in the determination data D. When determining in any of steps SC05 to SC07 that the commands are appropriate, the learning section 110 applies a positive reward R calculated by the reward calculation section 112 to the update formula of a function Q. When determining that the commands are inappropriate, the learning section 110 applies a negative reward R calculated by the reward calculation section 112 to the update formula of the function Q. Finally, in step SC08, the learning section 110 updates the action value table using the state variables S and the determination data D in the current state, the reward R, and the value of an action value (the updated function Q).

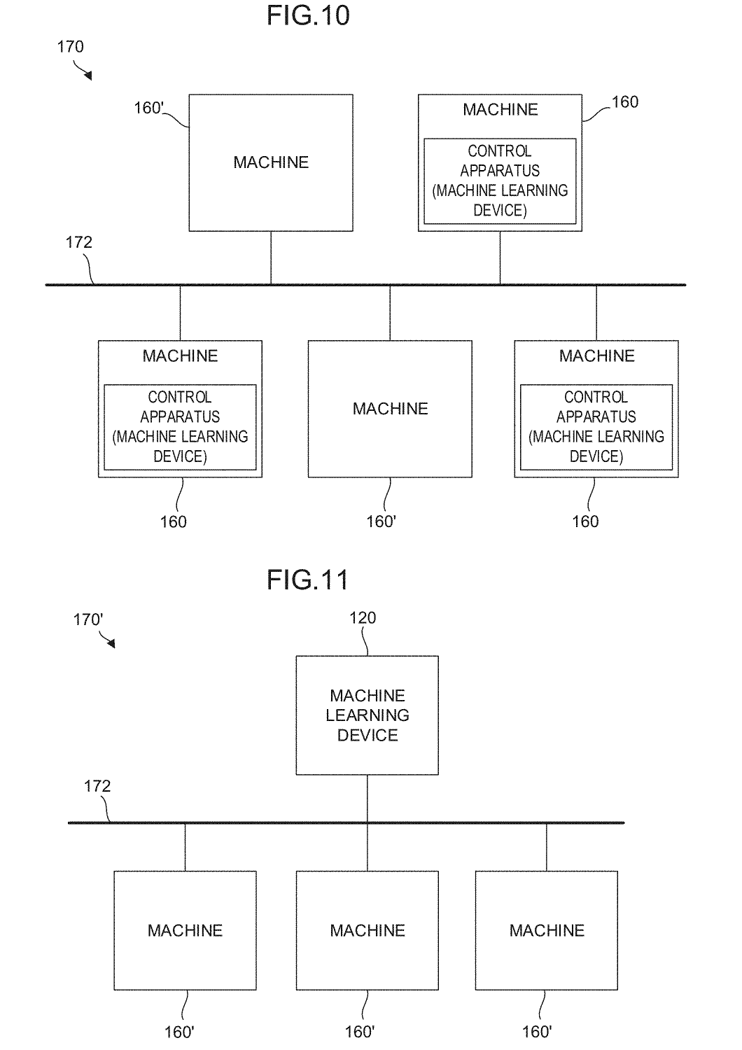

FIG. 10 shows a system 170 including machines 160 according to an embodiment. The system 170 includes a plurality of machines 160 and 160′ having the same type of configuration and a wired/wireless network 172 that connects the machines 160 and 160′ to each other. At least one of the plurality of machines 160 is configured as the machine 160 including the above control apparatus 2. Further, the system 170 may have the machines 160′ that do not include the control apparatus 2. The machines 160 and 160′ have a mechanism for performing an operation for the same purpose.

In the system 170 having the above configuration, the machines 160 including the control apparatus 2 among the plurality of machines 160 and 160′ may automatically and accurately calculate commands for the respective axes of the machines with respect to the movements (such as the positions, the feed rates, the accelerations, and the jerks) of the respective axes of the machines or the execution state of a program without relying on calculation or estimation using learning results of the learning sections 110. Further, the control apparatus 2 of at least one of the machines 160 may learn commands for the respective axes of the machine common to all the machines 160 and 160′ based on state variables S and determination data D obtained for each of the other plurality of machines 160 and 160′ so that the learning result is shared between all the machines 160 and 160′. Accordingly, the system 170 makes it possible to improve the feed rate and the reliability of learning the commands for the respective axes of the machines with a broader range of data sets (including state variables S and determination data D) as inputs.

FIG. 11 shows a system 170′ including machines 160′ according to another embodiment. The system 170′ includes a machine learning device 120 (or 100), a plurality of machines 160′ having the same type of configuration, and a wired/wireless network 172 that connects the machines 160′ and the machine learning device 120 (or 100) to each other.

In the system 170′ having the above configuration, the machine learning device 120 (or 100) may learn commands for the respective axes of the machines with respect to the movements (such as the positions, the feed rates, the accelerations, and the jerks) or the execution state of a program common to all the machines 160′ based on state variables S and determination data D obtained for each of the plurality of machines 160′, and automatically and accurately calculate the commands for the respective axes of the machines with respect to the movements (such as the positions, the feed rates, the accelerations, and the jerks) or the execution state of the program without relying on calculation or estimation using the learning result.

In the system 170′, the machine learning device 120 (or 100) may be configured to exist in a cloud server or the like provided in the network 172. According to the configuration, a desired number of the machines 160′ may be connected to the machine learning device 120 (or 100) where necessary regardless of the existing locations and the times of the plurality of machines 160′.

Workers engaging in the systems 170 and 170′ may determine whether the achievement degree of learning the commands for the respective axes of the machines (that is, the reliability of the commands for the respective axes of the machines) with the machine learning device 120 (or 100) has reached a required level at an appropriate timing after the start of learning by the machine learning device 120 (or 100).

### Third Embodiment

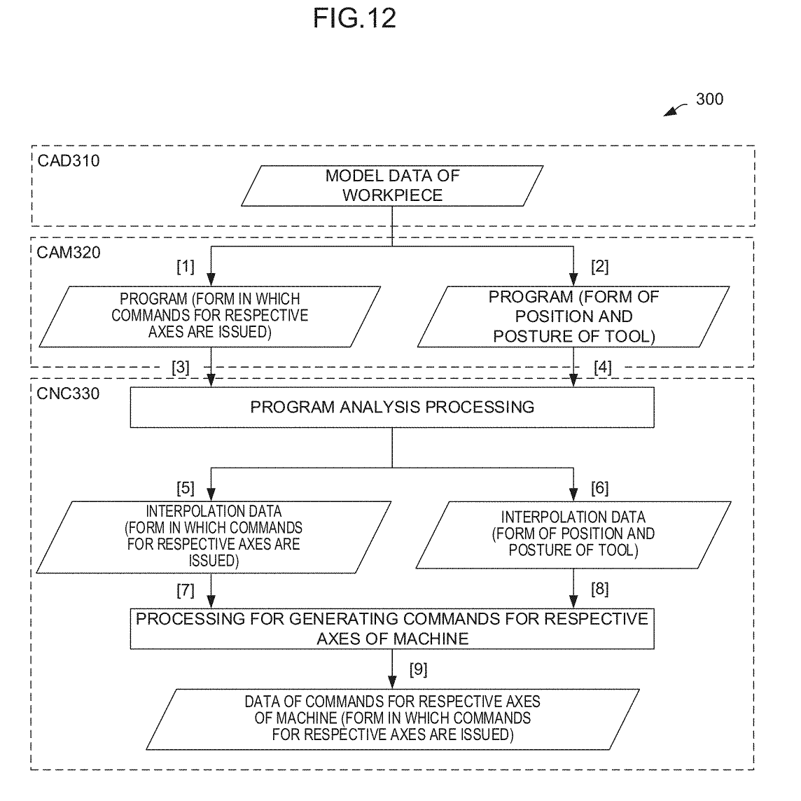

FIG. 12 is a diagram showing an example of a control system 300 using the above control apparatus 1 (or 2) as an element. The control system 300 has a CAD 310, a CAM 320, and a CNC 330. Here, the CNC 330 is the control apparatus 1 (or 2).

The CAD 310 creates the model data of a processed workpiece. The CAM 320 converts the model data created by the CAD 310 into a processing program. As the processing program, there are assumed two types including a form [1] in which commands for respective axes are issued, i.e., a form having no redundant degree of freedom in which the movements of the respective axes of a machine are specified, and the form [2] of the position and the posture of a tool, i.e., a form having a redundant degree of freedom. The program of the form [1] in which the commands for the respective axes are issued is described as, for example, the following form (2). Here, “X_Y_Z_” indicates the position of a straight-line axis or the position of the tool, and “B_C_” indicates the angle of a rotation axis. The program of the form [2] of the position and the posture of the tool is described as, for example, the following form (3). Here, “X_Y_Z_” indicates the position of the tool, and “I_J_K_” indicates the posture of the tool. Note that the output of any type of the programs of the forms [1] and [2] depends on the functions, the settings, or the like of the CAM 320.

X_Y_Z_B_C_; (2)

X_Y_Z_I_J_K_; (3)

The CNC 330 acquires the processing program [1] or [2] output by the CAM 320 ([3] or [4]) and analyzes the acquired processing program to generate interpolation data. As the interpolation data, there are assumed two types including a form [5] in which the commands for the respective axes are issued, i.e., a form having no redundant degree of freedom in which the movements of the respective axes of the machine are specified, and the form [6] of the position and the posture of the tool, i.e., a form having a redundant degree of freedom. The interpolation data of the form [5] in which the commands for the respective axes are issued is described as, for example, the following form (4). Here, “X_Y_Z_” indicates the position of the straight-line axis, and “B_C_” indicates the angle of the rotation axis. The interpolation data of the form [6] of the position and the posture of the tool is described as, for example, the following form (5). Here, “X_Y_Z_” indicates the position of the too, and “I_J_K_” indicates the posture of the tool.

X_Y_Z_B_C_; (4)

X_Y_Z_I_J_K_; (5)

When generating the interpolation data [5] (having no redundant degree of freedom) from the processing program [2](having a redundant degree of freedom), the CNC 330 inputs state variables S indicating the current movements (such as the positions, the feed rates, the accelerations, and the jerks) of the respective axes of the machine or the execution state of the program to the state observation section 106 of the machine learning device 100 or 120 and acquires corresponding commands for the respective axes of the machine as the output of the learning section 110. The CNC 330 may use the output as the interpolation data [5].

Subsequently, the CNC 330 generates the data [9] of commands for the respective axes of the machine based on the generated interpolation data [5] or [6] ([7] or [8]). Note that the data [9] of the commands for the respective axes of the machine does not have a redundant degree of freedom. The data [9] of the commands for the respective axes of the machine is described as, for example, the following form (6). Here, “X_Y_Z_” indicates the position of the straight-line axis, and “B_C_” indicates the angle of the rotation axis.

X_Y_Z_B_C_; (6)

When generating the data [9] of the commands (having no redundant degree of freedom) for the respective axes of the machine from the interpolation data [6] (having a redundant degree of freedom), the CNC 330 inputs state variables S indicating the current movements (such as the positions, the feed rates, the accelerations, and the jerks) of the respective axes of the machine or the execution state of the program to the state observation section 106 of the machine learning device 100 or 120 and acquires corresponding commands for the respective axes of the machine as the output of the learning section 110. The CNC 330 may use the output as the commands [9] for the respective axes of the machine.

Note that the control system 300 may also be used to cause the machine learning device 100 or 120 of the CNC 330 to perform learning. For example, the CNC 330 converts all the processing programs [3] and [4] output by the CAM 320 into the interpolation data [6] (having a redundant degree of freedom).

Then, the CNC 330 randomly selects one operation with a degree of freedom, i.e., the commands for the respective axes of the machine, evaluates a processing result with the method described as the first or second embodiment, and constructs a learning model.

The embodiments of the present invention are described above. However, the present invention is not limited to the examples of the above embodiments and may be carried out in other modes with the addition of appropriate modifications.

For example, a learning algorithm performed by the machine learning devices 100 and 120, a calculation algorithm performed by the machine learning device 120, and a control algorithm performed by the control apparatuses 1 and 2 are not limited to the above algorithms, but various algorithms may be employed.

Further, the above embodiments describe the control apparatus 1 (or 2) and the machine learning device 100 (or 120) as those having different CPUs. However, the machine learning device 100 (or 120) may be realized by the processor of the control apparatus 1 (or 2) and a system program stored in a storage unit.

Further, the above embodiments describe an example in which the positions, the feed rates, the accelerations, and the jerks as the data indicating the movements of the respective axes of the machine are used as the state variables S. However, only part of the data may be used as the state variables S, or other data indicating the movements of the respective axes of the machine may be used as the state variables S. Further, the above embodiments describe an example in which the feed rate and the position (or the cycle time, the processing accuracy, and the processing surface quality) of the tool as data indicating processing results are used as the determination data D. However, only part of the data may be used as the determination data D, or other data indicating processing results may be used as the determination data D.

Further, the above embodiments describe an example (FIG. 6) in which the feed rate and the position of the tool as the determination data D may be used to calculate the rewards R, and an example (FIGS. 7A and 7B) in which the cycle time, the processing accuracy, and the processing surface quality as the determination data D may be used to calculate the rewards R. However, the present invention is not limited to the examples. Only part of the determination data D may be used to calculate the rewards R, or other determination data D indicating processing results may be used to calculate the rewards R. That is, elements required to be considered to optimize the commands for the respective axes of the machine, i.e., the determination data D relating to desired processing results may be used to calculate the rewards R. For example, when the purpose is only to reduce processing time, it is only required to use the feed rate or the cycle time of a tool relating to the processing time as the determination data D to calculate the rewards R. When the purpose is to realize both reduction in processing time and improvement in processing accuracy, it is only required to use both the feed rate and the cycle time of a tool relating to the processing time and the position and the processing accuracy of the tool relating to the processing accuracy as the determination data D to calculate the rewards R.

Further, the above embodiments mainly describe an example in which the learning section 110 constructs the learning model indicating the correlation between the movements (such as the positions, the feed rates, the accelerations, and the jerks) of the respective axes of the machine or the execution state of the program and the commands for the respective axes of the machine. However, the present invention is not limited to the example. The learning section 110 may also construct a learning model indicating the correlation between the movements (such as the positions, the feed rates, the accelerations, and the jerks) of the respective axes of the machine or the execution state of the program and interpolation data.

Further, the first embodiment mainly describes the method for constructing the model through the learning, and the second embodiment mainly describes the method for advancing the learning while performing the processing (outputting the commands for the respective axes of the machine). However, in actual processing, the learning model constructed according to the above method may be repeatedly used to operate the control apparatus 1 (or 2) without performing new learning.

Further, the above embodiments describe an example in which the control apparatus 1 (or 2) repeatedly performs actual processing to advance the learning. However, the present invention is not limited to the example. A processing simulation may be repeatedly performed to advance the learning.

Basically, the learning is preferably performed for each workpiece. This is because optimum commands for the respective axes of machines are different depending on workpieces. However, it is also possible to apply an existing learning model to the processing of a similar workpiece. The similar workpiece indicates a workpiece having a small difference in processing such as a workpiece different only in diameter from, for example, a workpiece serving as a learning target.

Further, a workpiece may be divided into a plurality of pieces to perform learning for each of the pieces. On this occasion, it is also possible to separately consider a processing purpose for each of the pieces. That is, when it is desired to process a part of the workpiece with emphasis placed on quality and process a part of the workpiece with emphasis placed on a feed rate, different determination data D may be used for each of the pieces to create different learning models.

The embodiments of the present invention are described above. However, the present invention is not limited to the examples of the above embodiments and may be carried out in other modes with the addition of appropriate modifications.

1. A control apparatus outputting commands for respective axes of a machine having a redundant degree of freedom, the control apparatus comprising:
a machine learning device that learns
the commands for the respective axes of the machine, wherein
the machine learning device has:
a state observation section that observes, as state variables expressing a current state of an environment, data indicating movements of the respective axes of the machine or an execution state of a program;
a determination data acquisition section that acquires determination data indicating an appropriateness determination result of a processing result; and
a learning section that learns the movements of the respective axes of the machine or the execution state of the program and the commands for the respective axes of the machine, which are associated with one another, by using the state variables and the determination data.

2. The control apparatus according to claim 1, wherein
the state variables include at least any one of positions, feed rates, accelerations, and jerks as the data indicating the movements of the respective axes of the machine.

3. The control apparatus according to claim 1, wherein
the determination data includes an appropriateness determination result of at least any one of a feed rate and a position of a tool.

4. The control apparatus according to claim 1, wherein
the determination data includes an appropriateness determination result of at least any one of cycle time, processing accuracy, and processing surface quality.

5. The control apparatus according to claim 1, wherein
the learning section has:
a reward calculation section that calculates a reward relating to the appropriateness determination result; and
a value function update section that updates, by using the reward, a function expressing values of the commands for the respective axes of the machine with respect to the movements of the respective axes of the machine or the execution state of the program.

6. The control apparatus according to claim 1, wherein
the learning section performs calculation of the state variables and the determination data in a multilayer structure.

7. The control apparatus according to claim 1, further comprising:
a decision-making section that outputs a command value indicating the commands for the respective axes of the machine on the basis of a learning result of the learning section.

8. The control apparatus according to claim 1, wherein
the learning section learns the commands for the respective axes of the machine by using the state variables and the determination data obtained from a plurality of machines.

9. The control apparatus according to claim 1, wherein
the machine learning device exists in a cloud server.

10. A learning device learning commands for respective axes of a machine having a redundant degree of freedom, the learning device comprising:
a state observation section that observes, as state variables expressing a current state of an environment, data indicating movements of the respective axes of the machine or an execution state of a program;
a determination data acquisition section that acquires determination data indicating an appropriateness determination result of a processing result; and
a learning section that learns the movements of the respective axes of the machine or the execution state of the program and the commands for the respective axes of the machine, which are associated with one another, by using the state variables and the determination data.
